(19) United States
(12) Patent Application Publication
(10) Pub. No.: US 2004/0143489 A1
(43) Pub. Date: Jul. 22, 2004

(54) System and method for facilitating a performance review process

(75) Inventor: Andrew N. Garman, Palatine, IL (US)

Correspondence Address: FOLEY & LARDNER, 777 EAST WISCONSIN AVENUE, SUITE 3800, MILWAUKEE, WI, 53202-5308, US

(73) Assignee: Rush-Presbyterian - St. Luke's Medical Center

(21) Appl. No.: 10/348,194

(22) Filed: Jan. 20, 2003

(51) Int. Cl. G06F 17/60

(52) U.S. Cl. 705/11

(57) ABSTRACT

A method for facilitating a performance review process. The method comprises receiving a list of reviewers and their relationship to a reviewee, generating an evaluation form for each reviewer based on the relationship between the reviewer and the reviewee, providing each reviewer with access to the evaluation form for completion, processing the completed evaluation form, and providing an evaluation results report.

### FIELD OF THE INVENTION

The present invention relates generally to performance review systems. More particularly, an exemplary embodiment of the present invention relates to systems and methods for facilitating a performance review process.

### BACKGROUND OF THE INVENTION

Performance review is a valuable part of creating and maintaining an efficient optimized workforce. The data received in a performance review can be used to determine strengths and weaknesses in any type of business unit, such as a corporation, a department, or an individual. These strengths and weakness can be examined to capitalize on the strengths and improve or reduce the impact of the weaknesses.

Numerous performance review systems have evolved to capture performance review data. Traditional systems tend to identify and grade skills rather than evaluate performance. Additionally, traditional systems burden reviewers with a multiplicity of evaluation forms that have not been customized to correlate to company goals.

360 degree review systems have evolved to overcome these shortcomings. 360 degree feedback, referred to as multi-rater appraisals, multi-source feedback, or 360 degree profiling, is a process for receiving reviews from people around the person being reviewed. Reviewers can include a manager, peers, direct reports, clients, support personnel, etc. Additionally, the subject matter of the review can include a broader range of information in addition to the traditional skill information, such as behavior and competency information.

The 360 degree review process has traditionally been implemented by an external firm that prepares the evaluation forms, receives the completed forms, and aggregates the received data. Alternatively, a manager receives all of the forms and is forced to review them individually to analyze the results. The forms themselves are mailed to the reviewers who must complete them and them mail the form back to the person in charge of analyzing the results. Such a process can be expensive, time consuming and difficult to administer.

Accordingly, what is needed is a 360 degree review system and method that is easily customizable to allow an administrator to customize the evaluation form in accordance with corporate goals. Further, what is need is a system and method that facilitates the evaluation process by managing the administrative tasks of distributing evaluations forms, receiving feedback, aggregating information, and reporting results.

### SUMMARY OF THE INVENTION

An exemplary embodiment relates to a method for facilitating a performance review process. The method comprises receiving a list of reviewers and their relationship to a reviewee, generating an evaluation form for each reviewer based on the relationship between the reviewer and the reviewee, providing each reviewer with access to the evaluation form for completion, processing the completed evaluation form, and providing an evaluation results report.

Another exemplary embodiment is related to a system for facilitating a performance review process. The system comprises an interface for receiving and transmitting information related to a performance review process, a question database including questions related to a performance review process, and a rules database including rules governing population of a performance review evaluation form with questions from the question database based upon a relationship between a reviewer and a reviewee.

Another exemplary embodiment is related to an application hosted by a server system configured to facilitate a performance review process. The application comprises means for receiving a list of reviewers and their relationship to a reviewee, means for generating an evaluation form for each reviewer based on the relationship between the reviewer and the reviewee, means for providing each reviewer with access to the evaluation form for completion, means for processing the completed evaluation form, and means for providing an evaluation results report.

Other principle features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals denote like elements, and:

FIG. 1 is a flowchart illustrating a method of facilitating a performance review process according to an exemplary embodiment;

FIG. 2 is a flowchart illustrating a method of processing a completed evaluation form for a performance review process according to an exemplary embodiment;

FIG. 3 is a diagrammatical representation of a computer system for facilitating a performance review process according to an exemplary embodiment;

FIG. 4 is a diagrammatical representation of a system for facilitating a performance review process according to an exemplary embodiment; and

FIG. 5 is a diagrammatical representation of the computer system of FIG. 3 in a networked environment according to an exemplary embodiment.

### DETAILED DESCRIPTION OF EXEMPLARY EMBODIMENTS

A system for and method of facilitating a performance review process are described. In the following description, for purposes of explanation, numerous specific details are set forth in order to provide a thorough understanding of the present invention. It will be evident, however, to one skilled in the art that the exemplary embodiments may be practiced without these specific details. In other instances, structures and devices are shown in block diagram form in order to facilitate description of the exemplary embodiments.

In one embodiment, a computer system is used which has a central processing unit (CPU) that executes sequences of instructions contained in a memory. More specifically, execution of the sequences of instructions causes the CPU to perform operations, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

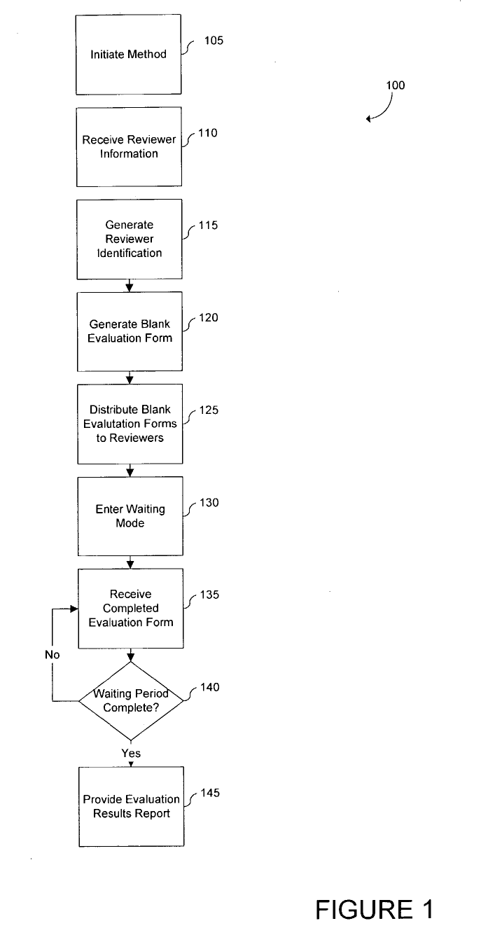

FIG. 1 is a flowchart illustrating an exemplary method 100 of facilitating a performance review process according to an exemplary embodiment. The method can be performed by an administrator of the performance review process for a single selected reviewee or reiteratively performed for multiple reviewees. An administrator can be any person or entity coordinating the performance review process. According to an exemplary embodiment, a reviewee can be an employee of the administrator. According to an alternative embodiment, the reviewee can be a business unit within a corporation or any other entity that interacts with and would benefit from feedback from entity contacts. According to yet another alternative embodiment, the reviewee may also be the administrator who is seeking to obtain feedback from contacts as a part of a self evaluation process. According to yet another exemplary embodiment, the administrator may delegate some or all of the administrator actions to the reviewee such that the process is driven in whole or in part by the reviewee while still ultimately controlled by the administrator.

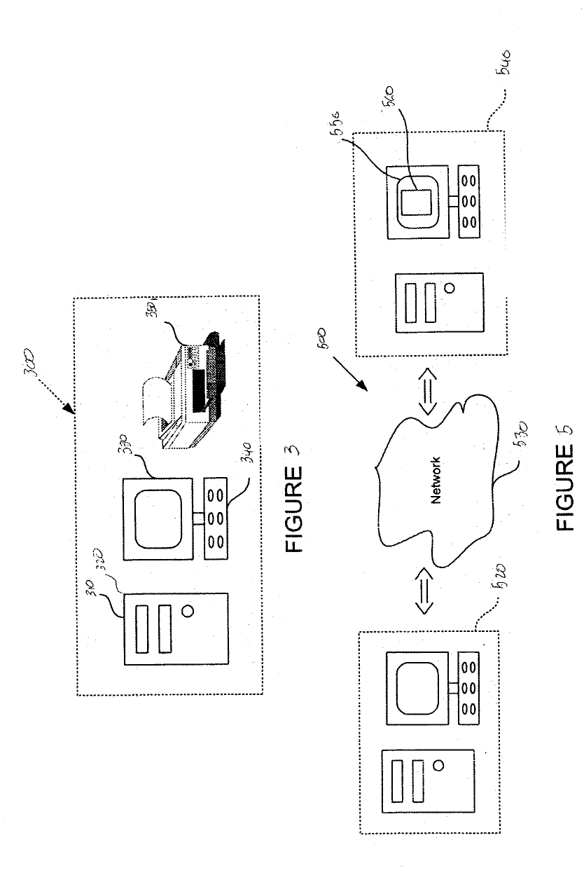

Method 100 is described as a web-based application according to an exemplary embodiment. An exemplary implementation of the web based application and supporting systems are described below with reference to FIGS. 3 and 5.

In an operation 105, the administrator can access a web page or computer application to initiate method 100. Access to the web page or computer application can be restricted through an enrollment process to control access to the method and any underlying data that is entered by the administrator, the reviewee, and any reviewers. Restriction methods can include password protection, encryption methods, secure terminals, or any other method of restricting access to data.

According to an exemplary embodiment, the enrollment process can further include a payment method for receiving a payment for the use of method 100. Receiving a payment can include receiving a subscription fee for unlimited access to method 100, a fee based on the number of evaluation to be solicited, or any other payment method or schedule.

Following enrollment, the administrator is provided with an interface for receiving a list of reviewers and their associated data. Associated data can include names, relationship (such as peer, direct report, supervisor, customer, supplier, etc.), contact information (such as email or mailing address), and any other fields are deemed relevant. The interface can include providing text entry boxes for receiving the information, providing a link to upload a file containing the relevant information or any other method for receiving the reviewer information.

After the list of reviewers is completed in operation 110, an operation 115 can be performed wherein a unique REVIEWER LOGIN ID is randomly generated for each proposed reviewer. Operation 115 can further include generation of a security method for protecting and verifying the identity of a reviewer when a completed evaluation form is returned by a reviewer. According to an exemplary embodiment, the security method can include providing a password associated with the REVIEWER LOGIN ID to the reviewer under separate cover. When the completed evaluation form is received, the evaluation will only be processed if the REVIEWER LOGIN ID and the password correlate.

Following generation of the REVIEWER LOGIN ID in operation 115, a blank evaluation form can be generated for each reviewer submitted in an operation 120. According to an exemplary embodiment, the blank evaluation form can be a standard 360 degree evaluation form. The standard 360 degree evaluation form includes a variety of questions designed to capture the strengths and weaknesses of the reviewee. The reviewer is provided with an opportunity to rate the reviewee on a scale of 1 to 10.

According to an alternative embodiment, the blank evaluation form can be customized based upon the relationship associated with each selected reviewer. Customizing the blank evaluation form according to the relationship of the reviewer provides the advantage of providing questions that are most relevant to the particular reviewer. For example, the questions that would provide the most benefit may be different for a supervisor compared to a direct report or a peer.

According to yet another alternative embodiment, the questions included in the blank evaluation form can be completely customizable. The administrator can type the question to be asked in a text entry box for inclusion in the blank evaluation form. The administrator can further specify a type of response desired from the reviewer, such as a rating from 1 to 10, a yes or no, or a short paragraph. The administrator may also create a set of questions or configuration of questions. The set of questions or configuration of questions may further be associated with a given reviewer-reviewee relationship (e.g. direct report question set, supervisor question set, etc.)

According to yet another exemplary embodiment, the blank evaluation form can be populated with questions using some combination of the above described methods or using any other customization method. Advantageously, making the blank evaluation form easily customizable while still providing a template maximizes both known benefits of certain types of questions while allowing the questions to reflect corporate or personal goals or concerns.

Following generation of a blank evaluation form for each reviewer, the blank evaluation forms can be distributed to the reviewers in an operation 125. According to an exemplary embodiment, the blank evaluation forms can be distributed by sending a hyperlink to each reviewer in an email allowing the user to access a web page containing the evaluation form generated for that reviewer. Access to the email can be restricted to require provision of the REVIEWER LOGIN ID and any security method that has been implemented. Receipt of the email by the intended recipient may also be tracked to maintain security and the integrity of the review process. Advantageously, providing a link in an email reduces the amount of paper flowing and decreases the amount of time required to be spent and level of difficulty faced by a reviewer.

The web page can include a listing of the questions to be answered by the reviewer and an input entry field configured to receive the reviewer's rating. Accordingly, where a rating from 1 to 10 is sought, any input for receiving a number from 1 to 10, such as a number entry field, a sliding scale, etc., can be included.

According to an exemplary embodiment, the web page can further include other information that may be of interest to the reviewer. For example, where the reviewer is a supervisor, the web page can include a summary of the reviewee's accomplishments. The reviewee's accomplishments can be provided by the reviewee or an independent entity, or automatically generated, such as performance on easily quantifiable metrics. Further information can include information on the performance review process, statements regarding the confidentiality of the review process, or any other information.

According to alternative embodiments, other distribution methods may be utilized. For example, the blank evaluation form itself may be included in the email to be completed by the reviewer and emailed back to the administrator, the form may be faxed to and from the reviewer, etc.

Following distribution of the blank evaluation forms, the program enters into a waiting mode in an operation 130 awaiting the return of completed evaluation forms. The waiting mode can have multiple configurations based on a selection by the administrator. According to an exemplary embodiment, the administer can select a time period, such as two weeks, wherein any evaluation forms that have not been completed within that period are not factored into the evaluation. According to an alternative embodiment, the administrator can select a participation percentage, such ending the waiting mode when 75% of the evaluation forms have been completed and returned. According to another exemplary embodiment, the administrator and/or the reviewee may track reviewer completion during the waiting period. According to yet another exemplary embodiment, periodic notices can be transmitted to the reviewers as reminders. Upon completion of the waiting period, an option to extend the waiting period may be provided such that the period can be extended if not enough responses have been received.

According to an exemplary embodiment, during the waiting mode in operation 130, a periodic check can be performed to determine the level of responsiveness based on the return of completed evaluation forms. A message, such as by email, can be sent to the administrator indicating the current and projected participation level. Additionally, a periodic reminder can be transmitted, such as by email, to the reviewers that have not yet returned a completed evaluation form.

During the waiting mode, completed evaluation forms will be processed in an operation 135. According to an exemplary embodiment, the processing of the completed evaluation form can be automated to the degree desired by the administrator. Advantageously, providing an automated system eliminates much of the time previously required in a review process.

According to an exemplary embodiment, for example, a human resources director that desires to conduct a performance review for an employee can log into a web site implementing method 100. The human resources director can access an existing account or enter one-time payment information. The human resource director can then enter the names of the persons or entities to review the employee, their relationship to the employee and their contact information. If desired, the human resources director can customize the evaluation forms to be provided to the reviewers to a greater or lesser degree. Thereafter, the human resources director need not take any further action until an evaluation review results report is received from the web site implementing method 100.

According to an alternative embodiment, the administrator can specify a grouping or sub-grouping of reviewers to be selected in whole or in part by the reviewee. Any method or combination of methods for selecting reviewers by the administrator and/or the reviewee can be implemented. For example, the administrator can select a supervisor and a few direct reports to be reviewers. The reviewee can then supplement this selection with peers, further supervisors, direct reports, etc.

The web site implementing method 100 receives the reviewer information and customizations to the evaluation forms. According to an exemplary embodiment, the web site sends an email containing a hyperlink to each of the reviewers. The hyperlink will connect the reviewer to a web page containing the evaluation form for the reviewee including data entry field to receive the reviewer's comments.

Upon completion of the evaluation form, the web site can parse the data received along with data from other completed evaluation forms and populate an evaluation review results report. Additional data and/or modified data and analysis can be included in the evaluation review results report to increase the value of the feedback provided in the evaluation review results report. The report can then be provided to the human resources director along with copies of the completed evaluations.

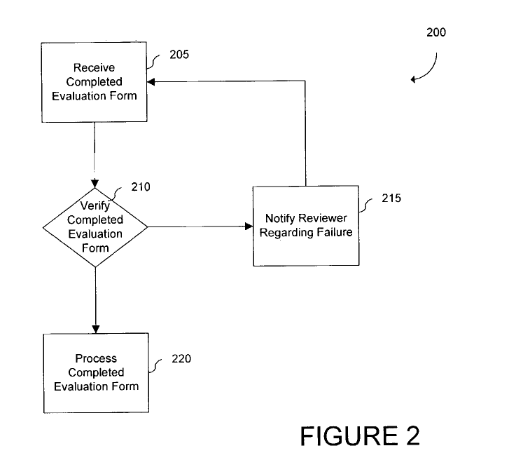

Referring now to FIG. 2, FIG. 2 illustrates a method 200 of processing completed evaluation forms in operation 130 according to an exemplary embodiment. In an operation 205, an email containing a completed evaluation form is received. According to an alternative embodiment, a submit button is clicked on a web page containing input entry fields. In an operation 210, the completed evaluation form can be parsed and analyzed to verify the integrity and completion of the completed evaluation form. If the evaluation form is found to be incomplete or corrupted in some way in operation 210, an email can be sent to the reviewer by return email in an operation 215.

Where the integrity and completion of the completed evaluation form is verified in operation 210, the completed evaluation form can be processed in an operation 220. According to an exemplary embodiment, in processing the completed evaluation form, it may be desirable to remove indications of the identity of the reviewer. The information can be transferred to an evaluation results report. Where the administrator is not the reviewee or anonymity is not required, copies of the completed evaluation forms can be provided to the administrator and/or reviewee for integrity checks or further review of both positive and negative evaluations.

The operations involved in the processing of the completed evaluation form can be dependent on the type of response solicited from the reviewer. For example, where a rating response was requested from the reviewer, the rating value can be parsed from the completed evaluation form. This rating value can then be compared and aggregated with the values from other reviewers to compose a composite rating for each of the questions. According to an alternative embodiment, the responses can be grouped according to a criteria, such as the relationship of the reviewer to the reviewee. For example, the response to a question from supervisors can be provided to compare to the response to a question from direct reports or peers.

Various data smoothing and statistical analysis techniques can also be applied to the responses to increase the usefulness of the response values. For example, outlying values can be removed, values can be adjusted according to a reviewer's tendency to universally give low or high ratings, standard deviations can be provided, etc.

Where the response to a question is not a value, such as a text response, the response can be copied into a report to be provided to the administrator. Text responses may also be automatically grouped for reporting purposes according to the nature of their content using automated keyword searching and sorting methods.

Referring again to FIG. 1, operation 135 can also be performed, to a greater or lesser degree, by the administrator. Following completion of operation 135, a check can be performed in an operation 140 to determine whether the waiting mode has completed.

If the waiting mode has completed, an evaluation results report can be provided to the reviewee and the administrator for review in an operation 145. This process can also be automated, such as by sending a copy of the evaluation results report by email, or by providing a link in an email to access a web page containing the evaluation results report.

According to an exemplary embodiment, the evaluation results report can be structured based on at least one characteristic of the reviewee. A characteristic of the reviewee can include the career goals of the reviewee. The ratings received by the reviewee can be compared to advancement benchmarks to indicate progression by the reviewee toward one or more career goals. Another characteristic of the reviewee can be the reviewee receptiveness to feedback. According to the receptiveness of the reviewee to feedback, the results can be displayed against benchmarks or simple ordered according to rank.

FIG. 3 illustrates a computer system 300 that can be used to implement method 100 described above with reference to FIG. 1. Computer system 300 can include a processor 310, a memory 320, a visual display unit 330, an input device 340, and an output device 350.

Computer system 300 can be any type of computing device, including work stations, laptops, notebooks, personal digital assistants (PDAs), or other equipment capable of receiving input from input device 340, accessing memory 320, executing a series of instructions and providing an output to visual display unit 330 or output device 350. Processor 320 can be any type of processor capable of executing instructions, such as an Intel® PENTIUM® processor sold by Intel Corp. of Santa Clara, Calif. Visual display unit 330 can be any type of visual display, such as a CRT tube monitor or an LCD display screen. Input device 340 can be a keyboard, a touchpad, voice recognition, file transfer, or any other method or apparatus for communicating information to standalone computing system 300. Output device 350 can be a laser printer, a dot matrix printer, an email program, or any other method or apparatus of communicating information from computer system 300.

According to an exemplary embodiment, system 300 can be utilized by a performance review administrator to facilitate a performance review. System 300 can be utilized to run software stored in memory 320 or provided on a removable media. The software can be a computer program implementing method 100 described above with reference to FIG. 1.

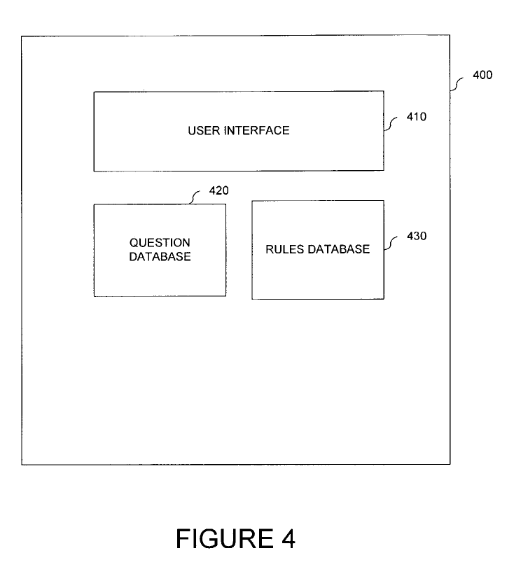

FIG. 4 is a block diagram illustrating the component parts of a system 400 facilitating performance reviews. According to an exemplary embodiment, system 400 can be implemented as a computer program for use with method 100. System 400 can be provided on removable media, memory associated with a computer, in memory associated with distributed computing systems in communication, or any other type of memory.

According to the exemplary embodiment, system 400 can include a user interface 410, a question database 420, and a rules database 430. User interface 410 can be any type of interface for providing information to and receiving instructions from a user of system 400. The interface can be a web page, a computer such as computer system 300, or any other type of interface.

According to an exemplary embodiment, question database 420 can be any type of memory configured to store and retrieve upon request at least one set of performance review questions. Question database 420 can include a standard set of 360 degree evaluation questions that have been shown to capture strengths and weaknesses. Question database 420 can also be modified to incorporate additional questions. The database can be modified by an administrator to incorporate questions that may be of particular relevance to the administrator.

According to an exemplary embodiment, rules database 430 can be a listing of predetermined associations between a field associated with a reviewer, such as the relationship, and a group of questions. For example, where a reviewer is the supervisor of a reviewee, rules database 430 may include a rule that suggests that a selected group of questions should be incorporated in the blank evaluation form that is provided to that reviewer. The rules in rules database 430 can be modified or created by an administrator.

FIG. 5 illustrates a system 500 for facilitating a performance review process in a network environment. System 500 can include a first computing system 520, a computer network 530, and a second computing system 540. Second computing system 540 further includes a web browsing application 550 capable of displaying a web page 560 provided by first computing system 520.

First computing system 520 and second computing system 540 can be any type of computer system, such as computer system 300, discussed in reference to FIG. 3. First computing system 520 and second computing system 540 further include devices for communicating over network 530.

According to an exemplary embodiment, network 530 is the Internet, a worldwide network of computer networks that use various protocols to facilitate data transmission and exchange. Network 530 can use a protocol, such as the TCP/IP network protocol or the DECnet, X.25, and UDP protocols. According to alternative embodiments, network 530 can be any type of network, such as a virtual private network (VPN), an Ethernet, or a Netware network. Further, network 530 can include a configuration, such as, a wide area network (WAN) or a local area network (LAN). Network 530 preferably provides communication with a Hypertext Markup Language (e.g. HTML, XML, DHTML).

Web browsing application 550 can be any type of application capable of accessing information stored on other computing systems over network 530. Examples can include applications such as Internet Explorer sold by Microsoft Corporation of Redmond, Wash. or Netscape sold by Netscape Communications Inc. of Mountain View, Calif. According to an exemplary embodiment, web browsing application 550 can be used to access first computing system 520, to receive data, and to display web page 560.

According to an exemplary embodiment, an administrator seeking to utilize method 100 to implement a performance review can access second computing system 540 and run web browsing application 550. Web browsing application 550 can be directed to retrieve web page 560 from first computing system 520 over network 530.

Once retrieved, web page 560 can be used by the administrator to provide inputs as described in reference to FIG. 1. The necessary input can include the list of reviewers and their associated information. Based on the inputs, first computing system 500 can interact with the administer to perform method 100. For example, first computing system can receive the inputs and generate blank evaluation forms based on rules database 430 and question database 420, described with reference to FIG. 4. The results of the evaluation can then be provided through web page 560.

While the exemplary embodiments illustrated in the figures and described above are presently preferred, it should be understood that these embodiments are offered by way of example only. Other embodiments may include, for example, a wide variety of ways to analyze and report mortgage loan information, such as, wireless application protocol (WAP), personal digital assistant (PDA) protocols, and other presentation means. Further, while exemplary embodiments describe the invention in the context of mortgage loan information, the invention may extend to other forms of loan information. The invention is not limited to a particular embodiment, but extends to various modifications, combinations, and permutations that nevertheless fall within the scope and spirit of the appended claims.

What is claimed is:

1. A method for facilitating a performance review process, the method comprising:
receiving a list of reviewers and their relationship to a reviewee over a network;
generating an evaluation form for each reviewer based on the relationship between the reviewer and the reviewee;
providing each reviewer with access to the evaluation form for completion over the network;
processing the completed evaluation form; and
providing an evaluation results report over the network.

2. The method of claim 1, wherein the relationship to the reviewee is at least one of supervisor, peer and direct report.

3. The method of claim 1, wherein generating an evaluation form includes populating the evaluation form with questions based on the relationship between the reviewer and the reviewee.

4. The method of claim 1, wherein providing each reviewer with access to the evaluation form for completion includes generating a unique reviewer identification for each reviewer.

5. The method of claim 4, wherein providing each reviewer with access to the evaluation form for completion further includes providing a hyperlink to a web page in an email transmitted to the reviewer.

6. The method of claim 5, further including requiring entry of the unique reviewer identification prior to allowing access to the web page

7. The method of claim 6, wherein access to the web page is controlled by a password.

8. The method of claim 1, wherein processing the completed evaluation form comprises
receiving a completed evaluation form from a reviewer;
parsing the contents of the completed evaluation form; and
populating the evaluation results report with the contents of the completed evaluation form.

9. The method of claim 8, wherein the evaluation results report is structured in accordance with at least one characteristic of the reviewee.

10. The method of claim 8, further including performing a data analysis function on the contents of the completed evaluation form prior to populating the evaluation results report.

11. The method of claim 1, wherein providing an evaluation results report includes transmitting an email containing a hyperlink to a web page containing the evaluation results report.

12. A system for facilitating a performance review process, the system comprising:
an interface for receiving and transmitting information related to a performance review process;
a question database including questions related to a performance review process; and
a rules database including rules governing population of a performance review evaluation form with questions from the question database based upon a relationship between a reviewer and a reviewee.

13. The system of claim 12, wherein the interface for receiving and transmitting information is a web page including text entry fields.

14. The system of claim 12, where information related to a performance review process includes a list of reviewers and their relationship to a reviewee.

15. The system of claim 12, wherein information related to a performance review process includes a list of reviewers and their relationship to a reviewee.

16. An application hosted by a server system configured to facilitate a performance review process, the application comprising:
means for receiving a list of reviewers and their relationship to a reviewee;
means for generating an evaluation form for each reviewer based on the relationship between the reviewer and the reviewee;
means for providing each reviewer with access to the evaluation form for completion;
means for processing the completed evaluation form; and
means for providing an evaluation results report.

17. The application of claim 16, wherein generating an evaluation form includes populating the evaluation form with questions based on the relationship between the reviewer and the reviewee.

18. The application of claim 16, wherein providing each reviewer with access to the evaluation form for completion includes providing a hyperlink to a web page in an email transmitted to the reviewer.

19. The application of claim 16, wherein processing the completed evaluation form comprises
receiving a completed evaluation form from a reviewer;
parsing the contents of the completed evaluation form; and
populating the evaluation results report with the contents of the completed evaluation form.

20. The application of claim 19, further including performing a data analysis function on the contents of the completed evaluation form prior to populating the evaluation results report.

21. The application of claim 19, further including structuring the evaluation results report in accordance with at least one characteristic of the reviewee.

22. The application of claim 16, wherein providing an evaluation results report includes transmitting an email containing a hyperlink to a web page containing the evaluation results report.
